(19) United States
(12) Patent Application Publication
(10) Pub. No.: US 2020/0128050 A1
(43) Pub. Date: Apr. 23, 2020

(54) CONTEXT BASED COMMUNICATION SESSION BRIDGING

(71) Applicant: Avaya Inc., Santa Clara, CA (US)

(72) Inventors: Mehmet Balasaygun, Freehold, NJ (US); Kurt Haserodt, Westminster, CO (US)

(21) Appl. No.: 16/163,846

(22) Filed: Oct. 18, 2018

(51) Int. Cl. H04L 29/06; H04L 12/18; H04L 29/08

(52) U.S. Cl. CPC H04L 65/1003; H04L 12/1822; H04L 67/14; H04L 65/403; H04L 65/1069

(57) ABSTRACT

An active communication session search parameter is dynamically received. For example, a user may type in a search parameter to identify all active communication sessions with a specific participant. One or more active communication sessions that meets the active communication session search parameter are identified. A representation of the one or more active communication sessions are displayed in a user interface to a user. The user can then bridge into a selected active communication session. For example, the selected active communication session may be a voice communication session. The bridging allows the user to listen to what is being said in the voice communication session and optionally participate in the voice communication session.

### FIELD

The disclosure relates generally to communication systems and particularly to searching for communication sessions based on a context.

### BACKGROUND

In today's communications systems, a bridging feature allows users to monitor and join active calls occurring elsewhere in the system. Awareness about active remote calls is provided through configuration of the communications system. For example, Avaya's Communication Manager (CM) is built on the line appearance concept and allows programming of bridged line appearances that allow certain users to monitor call/line activity for line appearances associated with certain other users. A slightly different shared line/call appearances/bridging concept is implemented in OpenSIP environment (e.g., Broadsoft's shared call appearances feature). The Broadsoft feature requires configuration of shared call appearance groups, similar to CM's bridged line appearance provisioning, before call monitoring and joining can be facilitated. Likewise, U.S. Patent Application Publication No. 2013/0039483 A1 (“Wolfld”) provides the ability to pre-program a bridging concept based on predefined criteria. However, these solutions fail to provide a contextual, dynamic representation of calls that may be of relevance to users that can easily be searched.

### SUMMARY

These and other needs are addressed by the various embodiments and configurations of the present disclosure. An active communication session search parameter is dynamically received. For example, a user may type in a search parameter to identify all active communication sessions with a specific participant. One or more active communication sessions that meets the active communication session search parameter are identified. A representation of the one or more active communication sessions are displayed in a user interface to a user. The user can then bridge into a selected active communication session. For example, the selected active communication session may be a voice communication session. The bridging allows the user to listen to what is being said in the voice communication session and optionally participate in the voice communication session.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other SIP RFCs describing SIP are hereby incorporated by reference in their entirety for all that they teach.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “communication session” is an electronic communication session between two or more users or between a user and a device, such as, an Interactive Voice Response (IVR) system, a contact center queue, a voicemail system, a chat bot, and Artificial Intelligence (AI) application, and/or the like. The communication session may be in any electronic media, such as voice, video (with voice), Instant Messaging (IM), email, text messaging, social media, gaming, virtual reality, multimedia, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for providing a dynamic communication session search engine for active communication session(s).

FIG. 2 is a block diagram of a second illustrative system for providing a dynamic communication session search engine for active communication session(s) across multiple networks.

FIG. 3 is a diagram of a user interface for providing a dynamic communication session search engine for active communication session(s).

FIG. 4 is a flow diagram of a process providing a dynamic communication session search engine for active communication session(s).

### DETAILED DESCRIPTION

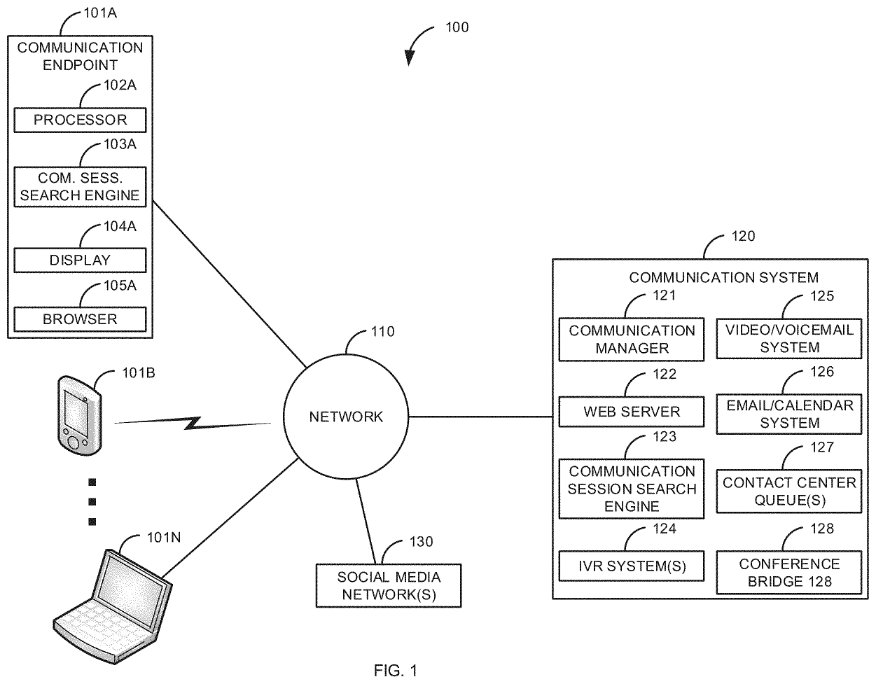

FIG. 1 is a block diagram of a first illustrative system 100 for providing a dynamic communication session search engine 103/123 for active communication session(s). The first illustrative system 100 comprises communication endpoints 101A-101N, a network 110, a communication system 120, and a social media network 130.

The communication endpoints 101A-101N can be or may include any user communication endpoint device that can communicate on the network 110, such as a Personal Computer (PC), a telephone, a video system, a cellular telephone, a Personal Digital Assistant (PDA), a tablet device, a notebook device, a smartphone, and/or the like. The communication endpoints 101A-101N are devices where a communication sessions ends. The communication endpoints 101A-101N are not network elements that facilitate and/or relay a communication session in the network 110, such as a communication manager 121 or router. As shown in FIG. 1, any number of communication endpoints 101A-101N may be connected to the network 110.

The communication endpoint 101A further comprises a processor 102A, a communication session search engine 103A, a display 104A, and a browser 105A. The processor 102A can be or may include any hardware processor, such as, a microprocessor, a micro-controller, an application specific processor, a multi-core processor, and/or the like.

The communication session search engine 103A can be or may include any software/firmware that allows a user to search for active communication sessions on the network 110, the communication system 120, and/or the social media network(s) 130. The communication session search engine 103A can work independently or in conjunction with the communication search engine 123 in the communication system 120. In one embodiment, the communication endpoint 101A may not have a communication session search engine 103A. For example, where the communication system 120, via the web server 122, provides a web page of the communication session search engine 123 via the browser 105A.

The display 104A can be or may include any hardware display, such as, a Light Emitting Diode (LED) display, a plasma display, a Liquid Crystal Display (LCD), a cathode ray tube display, a lamp, a touch screen display, and/or the like.

The browser 105A can be or may include any browser that can display one or more web pages provided by the web server 122. For example, the browser 105A may display a web page for the communication session search engine 123.

Although not shown for convenience, the communication endpoints 101B-101N may also comprise the elements 102-105. For example, the communication endpoint 101B may comprise a processor 102B, a communication search engine 103B, a display 104B, and a browser 105B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a corporate network, a combination of these, and/or the like. The network 110 can use a variety of electronic protocols, such as Ethernet, Internet Protocol (IP), Session Initiation Protocol (SIP), Integrated Services Digital Network (ISDN), video protocols, email protocols, Instant Messaging (IM) protocols, and/or the like. Thus, the network 110 is an electronic communication network configured to carry messages via packets and/or circuit switched communications.

The communication system 120 can be or may include any hardware coupled with software/firmware that can manage communication sessions, such as, a Private Branch Exchange (PBX), a central office switch, a router, a proxy server, a contact center, and/or the like. The communication system 120 further comprises a communication manager 121, a web server 122, a communication session search engine 123, an Interactive Voice Response (IVR) system(s) 124, a video/voicemail system 125, an email/calendar system 126, contact center queue(s) 127, and a conference bridge 128. In one embodiment, the communication system 120 may have a subset of the elements 121-128. For example, in a non-contact center environment, the communication system 120 may only comprise elements 121, 122, 123, 125, 126, and 128.

The web server 122 can be or may include any web server 122 that can provide web pages that are displayed in a browser 105. The web server 122, can be various types of known web servers 122, such as Apache HTTP Server™, Nginx™, Apache Tomcat™, Microsoft's Internet Information Services™, and/or the like.

The communication session search engine 123 can be or may include any software/firmware that can provide active communication search services in the communication system 120/network 110. The communication session search engine 123 can search various types of active communication sessions, such as, voice communication sessions, video communication sessions, Interactive Voice Response (IVR) system communication sessions, contact center queue communication sessions, Instant Messaging (IM) communication sessions, active social media communication sessions, gaming communication sessions, virtual reality communication sessions, voicemail/videomail communication sessions, communication sessions on hold, active email communication sessions, active text messaging applications, and/or the like.

The Interactive Voice Response (IVR) system(s) 124 can be or may include any hardware/software that can provide a voice interaction with a user. In one embodiment, the IVR system 124 may be a video IVR system. The IVR system(s) 124 may provide a series of menus that allow a user to establish a communication session with an entity, such as a contact center queue 127, a contact center agent, another user, and/or the like.

The video/voicemail system 125 can be or may include any hardware coupled with software/firmware that allows a user at a communication endpoint 101 to leave and/or listen to a video/voicemail message.

The email/calendar system 126 can be or may include any software/firmware that can provide email/calendaring for users of the communication endpoints 101A-101N, such as Microsoft's Outlook®.

The contact center queue(s) 127 can be or may include any computer construct that can hold communication sessions. For example, the contact center queue(s) 127 may comprise multiple contact center queues 127 that support multiple products in a contact center. The contact center queue(s) 127 may support multiple types of communication sessions, such as voice, video, email, IM, text messaging, virtual reality, and/or the like.

The conference bridge 128 can be or may include any hardware coupled with software/firmware that can conference communication sessions, such as, an audio mixer, a video bridge, a IM conference manager, and/or the like. The conference bridge 128 may conference in any number of communication endpoints 101A-101N into an active communication session. The conference bridge 128 may require a user to enter an access code to join the active communication session.

The social media network(s) 130 can be or may include any social media network, such as Facebook®, Twitter®, Linkedin®, YouTube®, Instagram, and/or the like. The communication session search engine 103/123 may access the social media networks 130 using different protocols/formats that are specific to each social media network 130.

Although not shown for convenience, the communication system 120 may include other elements, such as, an IM application, a gaming application, a virtual reality application, and/or the like. In one embodiment, some of the elements in the communication system 120 may be distributed on the network 110. For example, the video/voicemail system 125 and the email/calendar system 126 may be located on separate servers in the network 110.

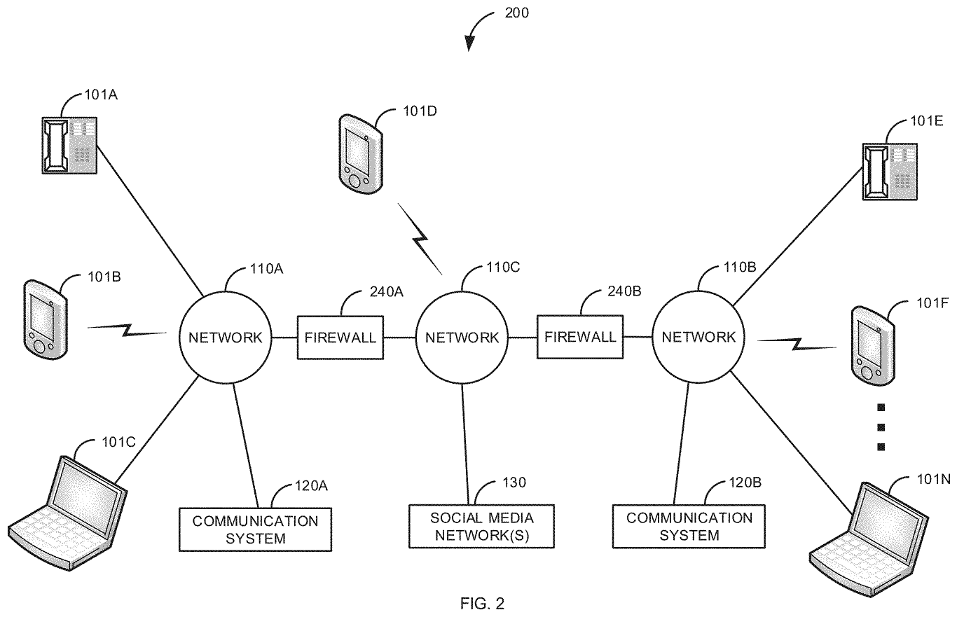

FIG. 2 is a block diagram of a second illustrative system for providing a dynamic communication session search engine 103/123 for active communication session(s) across multiple networks 110A-110C. The second illustrative system 200 comprises the communication endpoints 101A-101N, networks 110A-110C, communication systems 120A-120B, the social media network(s) 130, and firewalls 240A-240B. Although the networks 110A-110C show specific numbers of connected communication endpoints 101, any of the networks 110A-110C may have any number of connected communication endpoints 101.

The networks 110A-110C can be or may include any of the networks described for the network 110 in FIG. 1. In one embodiment, the networks 110A-110B are separate networks of a corporation or entity and the network 110C may be the Internet and/or PSTN (e.g., a public network).

The communication systems 120A-120B may include all or a subset of the elements 121-127. The communication systems 120A-120B may be separate communication systems 120 of a corporate network. The communication systems 120A-120B may help establish various types of communication sessions between the different networks 110A-110C. For example, the communication system 120A may help establish various types of communication sessions from any of the communication endpoints 101A-101C with any of the communication endpoints 101D-101N. Likewise, the communication system 120B may help establish various types of communication sessions between the communication endpoints 101E-101N and the communication endpoints 101A-101D.

The firewalls 240A-240B can be or may include any hardware coupled with software/firmware that can protect the networks 110A-110B, such as a Network Address Translator (NAT), a Session Boarder Controller (SBC), a communication address/port firewall, a virus scanner, and/or the like. For example, the firewalls 240A-240B may be used to protect the networks 110A-110B from hackers and viruses.

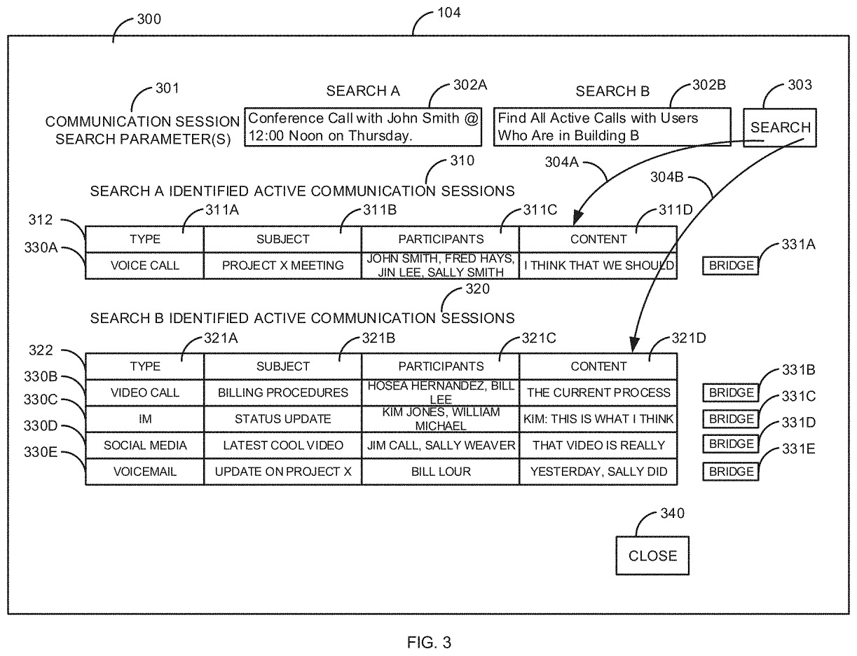

FIG. 3 is a diagram of a user interface 300 for providing a dynamic communication session search engine 103/123 for active communication session(s) 330. The user interface 300 is shown in the display 104 of the communication endpoint 101. The user interface 300 may be provided by the communication session search engine 103 and/or the web server 122/communication session search engine 123. For example, the user interface 300 may be provided in the browser 105 that is part of a web page provided by the web server 122/communication session search engine 123. Alternatively, the user interface 300 may be provided by the communication session search engine 103.

The user interface 300 comprises, a search parameter message 301, a search parameter A 302A, a search parameter B 302B, a search button 303, a search A identified active communication sessions 310, a search table A 312, a search A communication type 311A, a search A subject 311B, a search A participants 311C, a search A content 311D, a search B identified active communication sessions 320, a search table B 322, a search B communication type 321A, a search B subject 321B, a search B participants 321C, a search B content 321D, active communication sessions 330A-330E, bridge buttons 331A-331E, and a close button 340.

The search parameter message 301 is a message that tells a user to enter search parameter(s) in the search parameter A 302A and/or the search parameter B 302B. Initially, the search parameter A 302A and the search parameter B 302B are empty. The user may enter one or more search parameters for active communication sessions 330 in the search parameter A 302A and/or search parameter B 302B. For example, the user may enter separate search parameters in the search parameter A 302A by using commas, colons, semi-colons, specific characters, and/or the like to separate individual search parameters for the search parameter A 302A. Likewise, the user may enter one or more separate individual search parameters for a second search in the search parameter B 302B. As shown in FIG. 3, the user has entered the text string “Conference Call with John Smith @ 12:00 Noon on Thursday” in search parameter A 302A and “Find All Active Calls with Users Who Are in Building B” in search parameter B 302B.

After entering the search parameters 302A/302B and selecting the search button 303, the identified active communication sessions 330A-330E are displayed based on the entered search parameters 302A/302B in steps 304A and 304B respectively. The active communication session 330A is displayed in the search table A 312 under the search A identified active communication sessions 310. The search table A 312 has four headers that are used to identify characteristics of the active communication 330A. For example, the search A communication type 311A for the active communication session 330A identifies that it is an active voice call; the search A subject 311B identifies that the active communication session 330A is a meeting for “PROJECT X”; the search A participants 311C identifies that the participants are John Smith, Fred Hays, Jim Lee, and Sally Smith; the search A content 311D is a voice to text translation of what is currently being said in the active communication session 330A. The user can then select the bridge button 331A to bridge into the active communication session 330A. Depending upon implementation, bridging may be where the user can only listen to the active voice communication session 330A, or where the user can listen and actively participate in the active voice communication session 330A.

The search performed in steps 304A/304B may be performed based on information stored in various places, such as, the communication manager 121, the web server 122, the IVR system(s) 124, the video/voicemail system 125, the email/calendar system 126, the contact center queue(s) 127, the conference bridge 128, the social media network(s) 130, the communication endpoints 101A-101N, and/or the like. For example, the search of step 304A may be based on a calendar entry in the email/calendar system 126 that identifies a time, location (e.g., the conference bridge 128), and participants of the active communication session 330A. The information in the email/calendar system 126 may be used to identify a specific active communication session that is being supported by the conference bridge 128 that is then displayed as the active communication session 330A.

Likewise, for the search parameter B 302B, the active communication sessions 330B-330E are displayed in the search table A 322 under the search B identified active communication sessions 320. The identified active communication sessions 320 are typically limited only to communication sessions that the user may be allowed to view (e.g. based on permissions/rules). For example, an administrator may be able to view more active communication sessions identified by a search than another user making the same search. The search table B 322 has four headers that are used to identify characteristics of the active communications 330B-330E. For example, the search B communication type 321A for the active communication session 330B identifies that it is an active video call; the search B subject 321B identifies that the active communication session 330B is a meeting for “BILLING PROCEDURES”; the search B participants 321C identifies that the participants are Hosea Hernandez and Bill Lee; the search B content 321D is a voice to text translation of what is currently being said in the active communication session 330B. The user can then select the bridge button 331B in order to bridge into the active video communication session 330B.

In a similar manner, the search table B 322 displays the search B communication type 321A, the search B subject 321B, the search B participants 321C, and the search B content 321D for each of the communication session 330C-330D. The active communication session 330C is for an active Instant Messaging (IM) communication session. The active communication session 330D is for an active social media communication session. The active communication session 330E is for an active voicemail communication session (e.g., where a user is currently leaving a voicemail).

For active communication sessions, such as, voice, video, multimedia, IM, gaming, virtual reality, and/or the like (i.e., real-time communication sessions), a communication session is typically considered active while the communication session is established. This may include instances where the communication is placed on hold. For example, a user may be placed on hold while waiting in a contact center queue 127 or when placed on hold by another user. A supervisor in a contact center may want to bridge into an active communication session 330 where a user is waiting in a contact center queue 127 to see if the user is making any comments (e.g., where the user is getting impatient because of a long wait).

An active communication session 330 may be where a user is interacting with a device, such as the IVR system 124 or the video/voicemail system 125. For example, a user may want to identify and listen to what a caller interacting with the IVR system 124 is saying.

For communication sessions, such as, social media, email, text messaging, and/or the like (i.e., non-real-time communication sessions), the communication session may be deemed to be active based on a time of a last interaction in the communication session. For example, if the email/response to the email was sent in the last twenty minutes, the communication session may be deemed to be active. In addition, activity of a communication session may be based on a time between the last interaction and a previous interaction. For example, if a response to an initial email was received in the last twenty minutes and the initial email was sent with in the last forty minutes, the email will be deemed to be active. In other words, these types of non-real-time communication sessions are deemed to be active based on how recent one or more interactions have occurred in the communication session.

In addition, other factors may be considered when determining whether these types of communication sessions are active, such as, the number of users in the communication session, the type of communication session (e.g., the time values may be longer or shorter for a specific media type), activity of specific users (e.g., a ranking of users), and/or the like. For example, a social media communication session may be deemed to be active if a supervisor posted within the last hour versus a contact center agent that has posted within the last thirty minutes.

The user can bridge onto any of the active communication sessions 330A-330E using the bridge buttons 331A-331E. How the user bridges onto an active communication session 330 will vary based on the type of active communication session. For example, a user may bridge into an IM session by viewing the IM communication session and optionally becoming an active participant in the IM communication session. For social media, email, and text messaging, the user may bridge by viewing the text of the active communication session 330 and optionally being a full participant. For example, if the active communication session is a social media communication session (i.e., active communication session 330D), the user may select the bridge button 331D to view the active social media communication session 330D and then optionally make posts to a social media thread on the social media network 130.

For the active communication session 330E (a voicemail), the user may select the bridge button 331E to listen to a voicemail that is being left by Bill Lour on the video/voicemail system 125. The user may also be allowed to also speak in the voicemail being left on the video/voicemail system 125.

Once the user is done, the user can select the close button 340 to close the user interface 300.

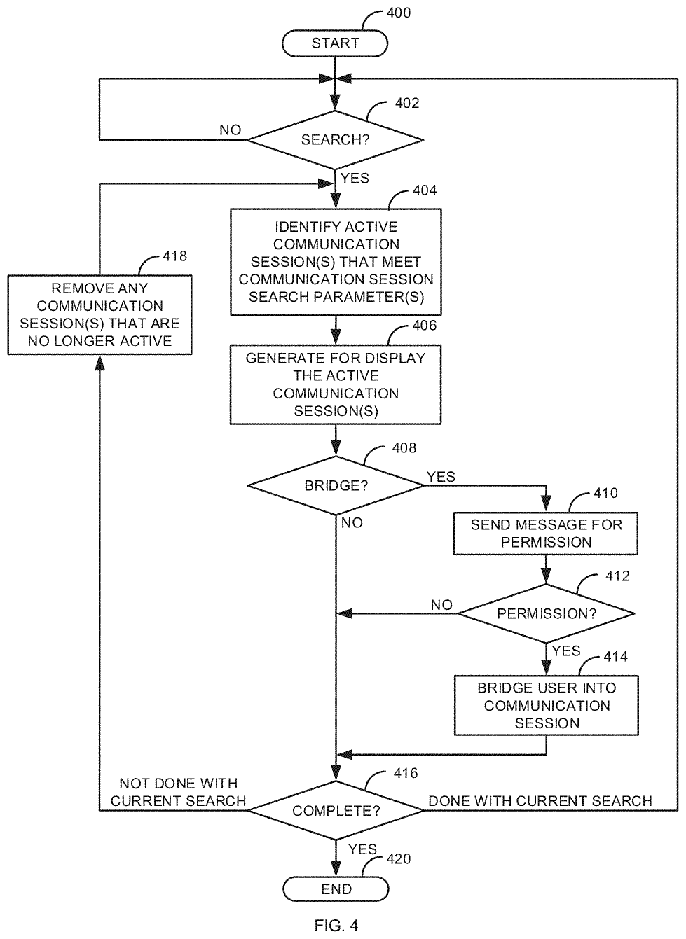

FIG. 4 is a flow diagram of a process providing a dynamic communication session search engine 103/123 for active communication session(s) 330. Illustratively, the communication endpoints 101A-101N, the communication session search engine 103, the display 104, the browser 105, the network 110, the communication system 120, the communication manager 121, the web server 122, the communication session search engine 123, the IVR system(s) 124, the video/voicemail system 125, the email/calendar system 126, the contact center queue(s) 127, the conference bridge 128, the social media network(s) 130, and the firewalls 250 are stored-program-controlled entities, such as a computer or microprocessor, which performs the method of FIGS. 3-4 and the processes described herein by executing program instructions stored in a computer readable storage medium, such as a memory (i.e., a computer memory, a hard disk, and/or the like). Although the methods described in FIGS. 3-4 are shown in a specific order, one of skill in the art would recognize that the steps in FIGS. 3-4 may be implemented in different orders and/or be implemented in a multi-threaded environment. Moreover, various steps may be omitted or added based on implementation.

The process starts in step 400. The communication session search engine 103/123 determines, in step 402, if the user has decided to initiate an active communication session search. For example, the user has selected the search button 303 after entering one or more search parameters 303A/302B. If a search has not been requested in step 402, the process of step 402 repeats.

Otherwise, if a search for an active communication session has been requested in step 402, the communication session search engine 103/123 identifies, in step 404, active communication session(s) that meet the communication search parameter(s). The identified active communication are those that the user has permissions to view/bridge. The search parameter(s) of step 404 may be based on various attributes, such as, keywords (e.g., a user name), key phrases (e.g., a product name), a location of a user in the active communication session (e.g., a physical location (e.g., using GPS) of the user/communication endpoint 101), a type of device being used by the user in the active communication session (e.g., a desktop computer), a type of the user in the active communication session (e.g., in a specific group, such as, product X technical support), a background object in the active communication session (e.g., a building), a conference session title, an avatar used in the active communication session (e.g., a gaming avatar), a game being played in the active communication session, a slide being presented in the active communication session, an agenda of the active communication session, and a picture being displayed in the active communication session (e.g., a specific type of picture), persons who are in a recipient field and/or sender field in an email, persons who are in a carbon copy or blind copy field in an email, and/or the like.

In addition, other types of information may be used in the search of steps 402/404, such as information in protocol headers. For example, information from Session Initiation Protocol (SIP) subject header (i.e., as defined in SIP RFC 3261, section 20.36) may be used to identify a specific active communication 330. The SIP header may include addresses, such as, in a “To:” field or a “From:” field that may be used to lookup a user. Likewise, an IP address may be used to identify a communication endpoint 101 of a user.

Moreover, the search of steps 402/404 may be performed on various systems and/or networks 110. For example, as shown in FIG. 2, the search may be performed by a communication search engine 123 in the communication system 120A that searches the communication system 120A/network 110A for the search parameter A 302A, and searches the communication social media network 130/network 110C/communication system 120B/network 110B for the search parameter 302B. For example, the location of building B in the search parameter B 302B (as shown in FIG. 3) may be all communication endpoints that are on the network 110B.

The communication session search engine 103/123 generates for display the active communication session(s) 330 in step 406. For example, as shown in FIG. 3, the active communication sessions 330A-330E are displayed in the user interface 300.

The communication manager 121 determines, in step 408, if the user wants to bridge into the active communication session 330. The bridging of step 408 may be where the user can only listen and/or view the active communication session 330, but not participate. Alternatively, the user can listen and/or view the active communication session 330 and actively participate. If the user does not want to bridge into the active communication session 330 in step 408, the process goes to step 416.

Otherwise, if the user wants to bridge into the active communication session 330 in step 408 (e.g., by user selecting one of the bridge buttons 331A-331E), a message may be optionally sent, in step 410, to one or more participants in the active communication session 330 asking of the user can bridge into the active communication session. If permission is not granted, in step 412, the process goes to step 416. Otherwise, if permission is granted in step 412, the user is bridged into active communication session 330 in step 414 and the process goes to step 416.

In one embodiment, the user may select a different user communication endpoint 101 to bridge into the active communication session. For example, the user may be using the communication endpoint 101A to select the active communication session 330. However, the user wants to join using her smartphone (e.g., communication endpoint 101B). In this embodiment, the user can select to join the active communication session 330 via the communication endpoint 101B.

The communication session search engine 103/123 determines, in step 416, if the process is complete. For example, if the user selects the close button 340. If the process is complete in step 416, the process ends in step 420.

If the process is not complete in step 416 and the user wants to continue with the current search, the communication session search engine 103/123 removes any active communication sessions 330 that are no longer active in step 418. For example, if the active communication session 330B (the voice call) of FIG. 3 ended, the active communication session 330B would be removed from the search table B 322 in step 418. Likewise, if the active communication session 330D (the social media communication session) was deemed no longer active (e.g., based on defined interaction time(s)) the active communication session 330D would be removed from the search table B 332 in step 418. The process then goes back to step 404 where the search results can be dynamically updated. For example, a new active communication session may be dynamically identified in step 404 and dynamically added to the display in step 406.

Otherwise, if the user is done with the current search in step 416, the process goes back to step 402. This allows the user to enter a new set of search parameters. For example, the user may enter new search parameters into the in the search parameter A 302A and/or the search parameter B 302B and select the search button 303.

In addition, machine learning may be used to learn the type of communication sessions that a user typically joins (e.g., based on the subject of a call or participant list) and starts providing suggestions to the user without doing a search query.

Examples of the processors 102 as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
dynamically receive an active communication session search parameter;
identify an active communication session that meets the active communication session search parameter; and
generate for display, in a user interface, a representation of the active communication session, wherein a user can select the representation of the active communication session to bridge into the active communication session.

2. The system of claim 1, wherein the identified active communication session comprises one of: a voice communication session, a video communication session, an Interactive Voice Response (IVR) system communication session, a contact center queue communication session, an Instant Messaging (IM) communication session, a social media communication session, a gaming communication session, a virtual reality communication session, a voicemail/videomail communication session, and a communication session on hold.

3. The system of claim 2, wherein the identified active communication session comprises one of: the Interactive Voice Response (IVR) system communication session, the contact center queue communication session, the voicemail/videomail communication session, and the communication session on hold.

4. The system of claim 1, wherein the dynamically received active communication session search parameter comprises a plurality of separate active communication session search parameters that are used to identify a plurality of separate groups of active communication sessions and wherein the microprocessor readable and executable instructions further program the microprocessor to: generate for display, in the user interface, representations of the plurality of separate groups of active communication sessions.

5. The system of claim 4, wherein the plurality of separate groups of active communication sessions comprises a first separate group of active communication sessions and a second separate group of active communication sessions, wherein the first separate group of active communication sessions is identified based on at least one of a first separate communication system and a first separate network, and wherein the second separate group of active communication sessions is identified based on at least one of a second separate communication system and a second separate network.

6. The system of claim 1, wherein identifying the active communication session that meets the active communication session search parameter is based searching a user calendar record to identify the active communication session.

7. The system of claim 1, wherein identifying the active communication session that meets the active communication session search parameter is based on at least one of: a location of a user in the active communication session, a type of device being used by the user in the active communication session, a type of the user in the active communication session, a background object in the active communication session, a conference session title, an avatar used in the active communication session, a game being played in the active communication session, a slide being presented in the active communication session, an agenda of the active communication session, a picture being displayed in the active communication session, a person in a sender field in an email, one or more persons who are in a recipient field the email, and one or more persons who are in at least one of a carbon copy and blind copy field in the email.

8. The system of claim 1, wherein identifying the active communication session that meets the active communication session search parameter is based information in a Session Initiation Protocol (SIP) subject header.

9. The system of claim 1, wherein the active communication session is one of: a social media communication session, an email communication session, and a text messaging communication session and wherein the active communication session is deemed to be active based on a time of a last interaction in the active communication session and a time between the last interaction and a previous interaction in the active communication session.

10. The system of claim 1, wherein the microprocessor readable and executable instructions further program the microprocessor to:
send a notification that the user wants to or is going to bridge into the active communication session.

11. A method comprising:
dynamically receiving, by a microprocessor, an active communication session search parameter;
identifying, by the microprocessor, an active communication session that meets the active communication session search parameter; and
generating for display, by the microprocessor, in a user interface, a representation of the active communication session, wherein a user can select the representation of the active communication session to bridge into the active communication session.

12. The method of claim 11, wherein the identified active communication session comprises one of: a voice communication session, a video communication session, an Interactive Voice Response (IVR) system communication session, a contact center queue communication session, an Instant Messaging (IM) communication session, a social media communication session, a gaming communication session, a virtual reality communication session, a voicemail/videomail communication session, and a communication session on hold.

13. The method of claim 12, wherein the identified active communication session comprises one of: the Interactive Voice Response (IVR) system communication session, the contact center queue communication session, the voicemail/videomail communication session, and the communication session on hold.

14. The method of claim 11, wherein the dynamically received active communication session search parameter comprises a plurality of separate active communication session search parameters that are used to identify a plurality of separate groups of active communication sessions and wherein the microprocessor readable and executable instructions further program the microprocessor to: generate for display, in the user interface, representations of the plurality of separate groups of active communication sessions.

15. The method of claim 14, wherein the plurality of separate groups of active communication sessions comprises a first separate group of active communication sessions and a second separate group of active communication sessions, wherein the first separate group of active communication sessions is identified based on at least one of a first separate communication system and a first separate network, and wherein the second separate group of active communication sessions is identified based on at least one of a second separate communication system and a second separate network.

16. The method of claim 11, wherein identifying the active communication session that meets the active communication session search parameter is based searching a user calendar record to identify the active communication session.

17. The method of claim 11, wherein identifying the active communication session that meets the active communication session search parameter is based on at least one of: a location of a user in the active communication session, a type of device being used by the user in the active communication session, a type of the user in the active communication session, a background object in the active communication session, a conference session title, an avatar used in the active communication session, a game being played in the active communication session, a slide being presented in the active communication session, an agenda of the active communication session, a picture being displayed in the active communication session, a person in a sender field in an email, one or more persons who are in a recipient field the email, and one or more persons who are in at least one of a carbon copy and blind copy field in the email.

18. The method of claim 11, wherein identifying the active communication session that meets the active communication session search parameter is based information in a Session Initiation Protocol (SIP) subject header.

19. The method of claim 11, wherein the active communication session is one of: a social media communication session, an email communication session, and a text messaging communication session and wherein the active communication session is deemed to be active based on a time of a last interaction in the active communication session and a time between the last interaction and a previous interaction in the active communication session.

20. A communication endpoint comprising:
a microprocessor; and
a computer readable medium, coupled with the microprocessor and comprising microprocessor readable and executable instructions that program the microprocessor to:
dynamically receive an active communication session search parameter;
identify or receive a representation of an active communication session that meets the active communication session search parameter; and
display, in a user interface, the representation of the active communication session, wherein a user can select the representation of the active communication session to bridge into the active communication session.
